(19) United States
(12) Patent Application Publication
(10) Pub. No.: US 2009/0144643 A1
(43) Pub. Date: Jun. 4, 2009

(54) System and method for configuration of a graphical user interface

(75) Inventor: Surendra Ramarao, Bangalore (IN)

Correspondence Address: Edwards Angell Palmer & Dodge LLP, P.O. Box 55874, Boston, MA, 02205, US

(73) Assignee: Yokogawa Electric Corporation, Tokyo (JP)

(21) Appl. No.: 12/156,840

(22) Filed: Jun. 5, 2008

(30) Foreign Application Priority Data
Sep. 26, 2007 (SG) 200708875-0

(51) Int. Cl. G06F 3/048

(52) U.S. Cl. 715/764

(57) ABSTRACT

The invention is a system for configuring and applying a graphical user interface which is used to monitor and control the process of making or treatment of a product. The system comprising a first repository having a plurality of function sources implementing pre-defined first and second interfaces, a second repository for storing the configured graphical user interface and the information of the selected function source, and a function link component.

### FIELD OF INVENTION

This invention relates to a system and method for configuration of a graphical user interface to include functions from different function sources.

### BACKGROUND OF THE INVENTION

A graphical user interface is commonly used to remotely monitor and control the process of making or treatment of a product. The configuration of the graphical user interface is very important to enable operators to visualise the processes which are being monitored or controlled. When monitoring or controlling the processes, an operator need to invoke certain functions for purposes such as data entry, open another graphical user interface, activate an external software program.

In the prior art, when an Engineer creates a graphical user interface using a Graphic Page Editor, the Engineer includes certain special Graphic Objects such as a function-linkable button or function-linkable hyperlink. From the function configuration page of such Graphic Objects, the Engineer selects the type of function to be executed when an Operator invokes the Graphic Object. The parameters are defined and the Graphic File, which includes the Graphic Object and defined parameters, is saved.

The prior art teaches a system and method of configuring a graphical user interface for monitoring and control of the proprietor's devices. In the proprietary software, a Touch Target component executes assigned functions, such as data entry, open another graphical user interface, or activate an external software program. The functions which are to be assigned to the Touch Target component is selected from the Function Tab of the user interface of the Touch Target component. An illustration of the graphical user interface for the system and method is shown in FIG. 1.

In FIG. 1, a Graphic Page 101 shows a tank 102 and its valve 103. In this example, the filling of the tank is being monitored and the filling is controlled by the valve. The Graphic Objects are the tank and valve. When an Operator selects the tank by clicking within a predefined area, a predefined function is invoked. For example, the Operator wants to check the temperature and fill-level of the tank, he clicks on or within an area of the tank. A window displaying the temperature and fill-level are shown. If the Operator wants to increase or reduce the flow rate, the valve or any predefined area is clicked to invoke the desired function.

In order to support the desired functionalities, during the configuration as shown in FIG. 1, an Engineer adds a Touch Target component by dragging the component from the tool bar over the area of the intended Graphic Object. In this case, the Graphic Object is the tank. The user interface 104 of the Touch Target component is displayed. The Engineer selects the Function Tab to enter the function which is to be assigned to the Touch Target component. The function can be selected from drop-down lists 105.

The system and method in the prior art only permits functions to be linked to Graphic Objects which are proprietary in nature. In addition the types of functions that can be linked are also limited and fixed to those supported by the graphical user interface. In the example, only specific functions in the proprietory software can be linked. Functions from other software cannot be used if the graphical user interfaces are not compatible.

### SUMMARY OF THE INVENTION

Briefly, the invention is a system for configuring and applying a graphical user interface which is used to monitor and control the process of making or treatment of a product comprising a first repository having a plurality of function sources implementing pre-defined first and second interfaces, a second repository for storing the configured graphical user interface and the information of the selected function source, and a function link component.

### BRIEF DESCRIPTION OF THE DRAWING

FIG. 1 illustrates a configuration page of a graphical user interface in the prior art.

FIG. 2 illustrates an example system of the invention.

FIG. 3 is a process diagram of the system in the design time.

FIG. 4 is a process diagram of the system in the run time.

FIG. 5 illustrates an example of a property page for a Graphic Object.

FIG. 6 illustrates an example of a user interface to enable function linking for a Graphic Object.

FIG. 7 is a Unified Modelling Language Diagram for the design-time interface.

FIG. 8 is a Unified Modelling Language Diagram for the run-time interface.

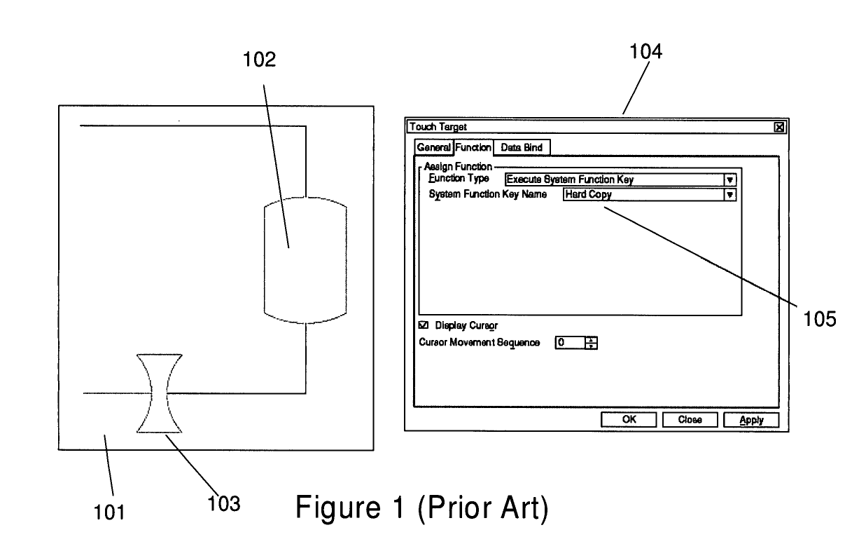

### DETAILED DESCRIPTION OF THE PREFERRED EMBODIMENT

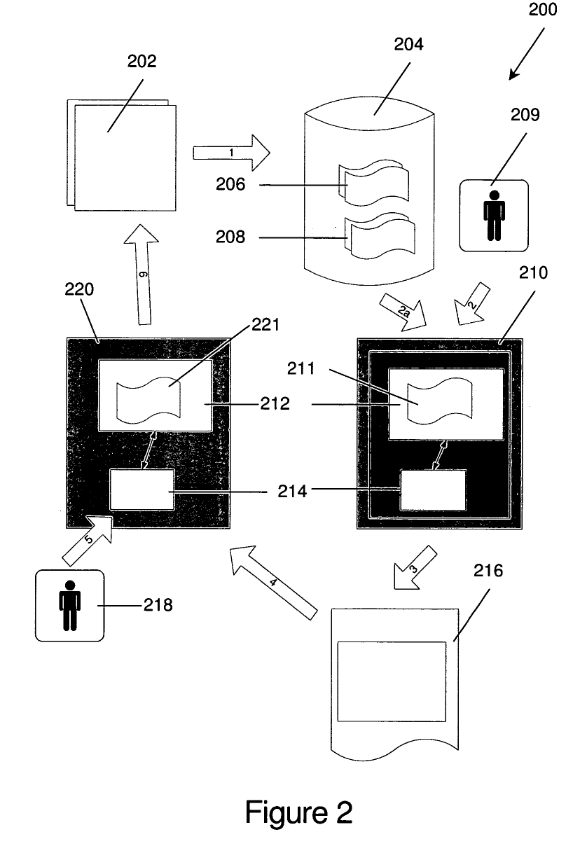

The invention is a system for configuring a graphical user interface to control and monitor the process of making or treatment of a product as shown in FIG. 2. In a system 200, Function Sources 202 are registered in a Function Source Repository 204. Each registered Function Source implements a first interface 206 and a second interface 208. The implemented first interface allows the Function Source to be added during the configuration or design-time of the graphical user interface, and the implemented second interface enables the Function Source to be activated during the application or run-time of the graphical user interface.

Each field device is represented by a Graphical Object 214 in the graphical user interface to enable its process monitoring and control. During the configuration of the graphical user interface, a design-time user, in this case an Engineer 209 loads a Graphic Editor 210 and the Function Source Repository. When the Graphic Editor is loaded, a Function Link Component 212 is provided in the Graphic Editor. When the Function Link Component is initialising, it queries the Function Sources Repository to load the implemented first interfaces for all the Function Sources.

The Function Link Component enables the Engineer to link a function to a Graphic Object by displaying the user interface 211 provided by the relevant Function Source along with the implemented first interface. The desired function is selected from the relevant Function Source. Upon completion of a graphical user interface, the Graphic Object and the information of the linked functions are stored in a Graphic File Repository 216.

During the application of the system, a run-time user, in this case, an Operator 218, monitors the Graphic Object from the graphical user interface by loading a Graphic Engine 220. The Graphic Engine loads the Graphic File from the Graphic File Repository. The Function Link Component queries the Function Sources Repository to load the second interfaces 221 for the Function Sources.

When the Operator invokes a function on the graphical user interface, the Function Link Component calls for the second interface of the relevant Function Source and passes all the required parameters. The second interface of the Function Source will invoke the actual function by passing all the required parameters.

The processes of the system in the design-time and run-time is further detailed below.

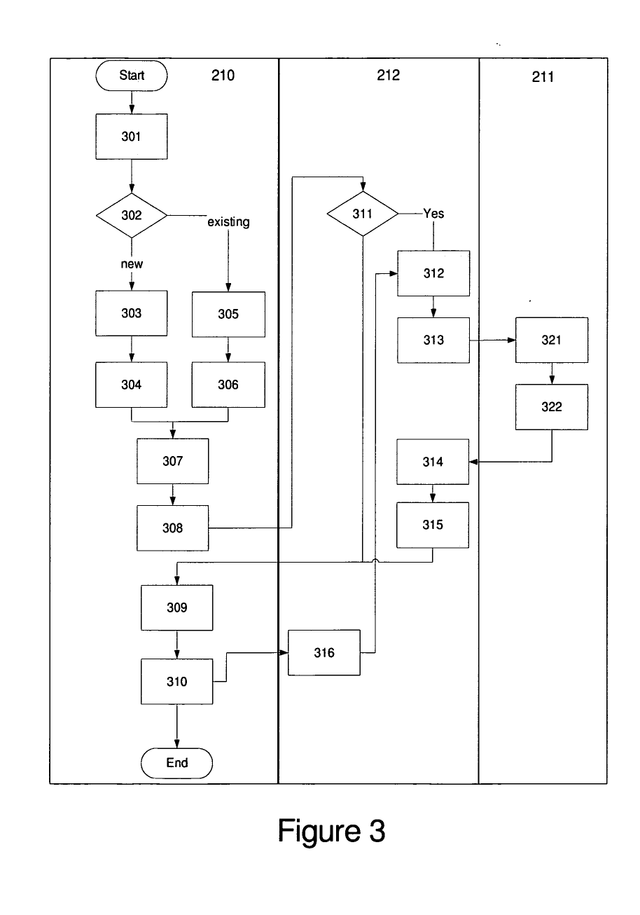

FIG. 3 is a process diagram of the system in the design time or configuration.

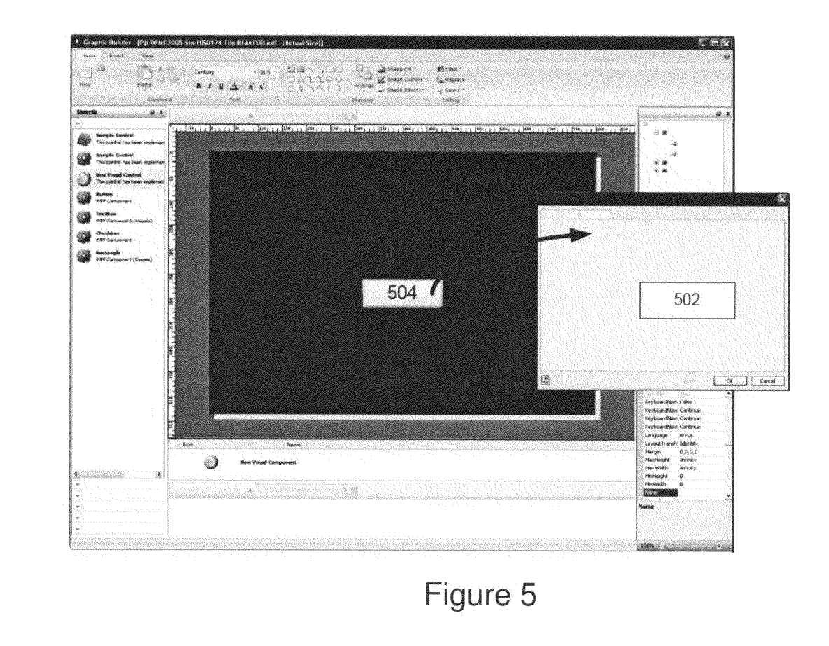

When an Engineer loads a Graphic Editor, Step 301 launches a Graphic Editor for creating a new graphic file or editing an existing one. Step 302 queries whether to create new graphic file. If the Engineer chooses to create a new graphic file, Step 303 creates a new graphic file and Step 304 adds a Function Link Component to the graphic file. If the Engineer chooses to open an existing graphic file, Step 305 opens an existing graphic file and Step 306 loads the Function Link Component. In the latter case, the Function Link Component has already been added to the graphic file when it is first created and saved. After the Function Link Component is added or loaded in Steps 304 or 306 respectively, the Engineer creates or edits Graphic Objects in Step 307. For each Graphic Object, the property page is shown in Step 308. We refer you to FIG. 5 which illustrates an example of a property page 502 for a Graphic Object 504 to enable function linking.

Back to the process diagram in FIG. 3, after activating the property page, the subsequent steps are done in the Function Link Component. In Step 311, the Function Link Component determines if the Graphic Object allows a function to be linked to it. If the Graphic Object can have a function linked to it, a user interface that enables function linking is shown in Step 312. The user interface can be part of the existing user interface. Preferably, the user interface lists the available Function Sources for selection that have been saved in a Function Sources Repository. The Function Sources in the repository have a first interface suitable for configuration and a second interface suitable for application. A function source is selected in Step 313.

For the selected function source, the user interface is provided with the implemented design-time interface is shown in Step 321. In Step 322, the Engineer selects and/or edits the functions. Preferably, the process condition that allows the function to be enabled is included. The function is further configured to allow an operator during run-time to specify at least one parameter when the function is invoked.

After configuring the function, the function is assigned an identifier in Step 314 by the Function Link Component. Preferably generic names are assigned as identifiers to enable ease of reference and use. In Step 315, the function and its information such as enabling process conditions, run-time parameters and assigned name are stored with the Graphic Object by the Function Link Component or the Graphic Editor. The Graphic Object and the information of the function links are stored in a Graphic File Repository.

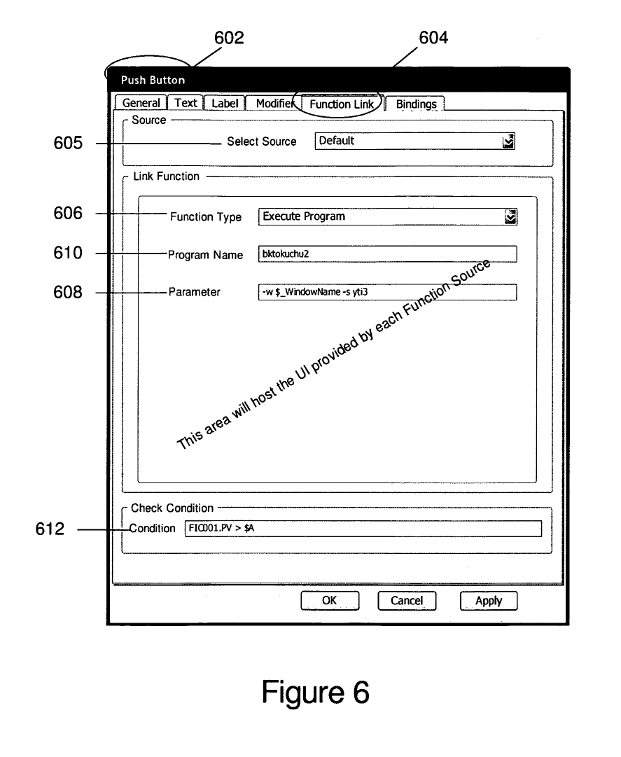

Before going further with the other steps in FIG. 3, we refer to FIG. 6 which illustrates an example of a user interface to enable function linking for a Graphic Object. In this illustration, the Graphic Object is a Push Button 602. The user interface is selected by the Function Link Tab 604. A Function Source is selected from a drop-down list 605. The function to be enabled is selected from the drop-down list for Function Type 606. The parameter is specified in the entry for Parameter 608. An identifier is named in the entry for Program Name 610. The Engineer can include a condition in the entry for Condition 612.

Referring back to FIG. 3 in Step 311, if a function cannot be linked to the Graphic Object, the other operations are performed in the Graphic Editor in Step 309. If the function can be linked and the linking has been completed, the other operations are also done in the Graphic Editor in Step 309. To add functions to be called at opening or closing of a graphic page, a user interface which enables such function linking is shown in Step 310. The user interface can be represented and activated by a tab in a current user interface.

The Engineer in Step 316 creates or edits other link functions in the Function Link Component. The subsequent steps are described previously as Steps 312, 313, 321, 322, 314, 315 and 309, 310. When all desired functions have been linked, the design time process is completed.

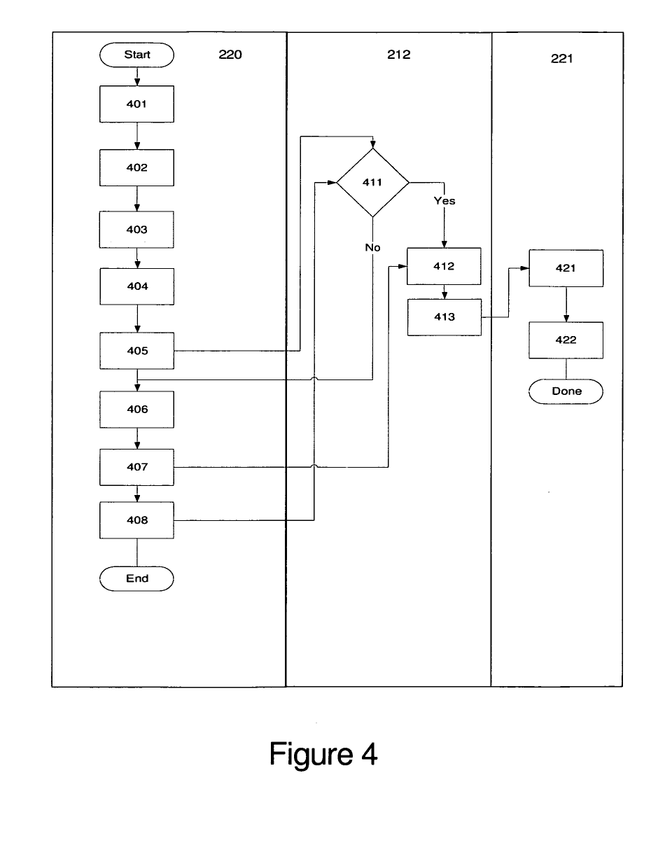

FIG. 4 is a process diagram of the system in the run time or application.

When an Operator monitors the process under control from the graphical user interface, Step 401 launches the Graphic Engine. Step 402 loads the Graphic File, Step 403 loads the Function Link Component. All the components are then initialised in Step 404 and Step 405 loads the Graphic File for the process being monitored.

In Step 411, the Function Link Component determines if there is a need to execute any linked functions. The Engineer may have configured some functions to be executed after initialisation of all the components. If no function has been configured as such, the Graphic Page is loaded in Step 406. In Step 407, the Operator calls a function which is linked to the Graphic Object. When a function is called in Step 407 or when the Function Link Component determines that a function needs to be executed in Step 411, the next step is Step 412. In Step 412, the parameters required for the function are input and any generic names are resolved by the Operator or the default parameters and names as previously configured by the Engineer are applied. In Step 413, the Steps 411, 412 and 413 are done using the Function Link Component to execute the function with the Operator-input or default parameters accordingly.

When the function is executed, the run-time interface of the Function Source for the function is loaded in Step 421. Using the run-time interface, the Function Source executes the function in Step 422. After the function is executed, the Operator continues to monitor the Graphic Object and invokes another function when the need arises.

When the Operator no longer needs to monitor the Graphic Object, the Graphic Page is closed in Step 408. Upon activating Step 408, the Function Link Component determines if there is a need to execute any functions in Step 411. The subsequent steps resulting from the decision from Step 411 are same as previously described.

The invention is further explained using a specific example, in this case a Graphic Object which is available from a Microsoft™ software. An example of a Graphic Object is a “Push Button” which can be included in a Graphic Page to invoke a function “Call Window”. The Graphic Object is used to invoke a function by implementing the ICommandSource Interface which is defined by Microsoft Windows Presentation Foundation. When the ICommandInterface is implemented, the following three properties will be exposed:
Command which is the command to execute when a command source is invoked;
CommandParameter which contains the parameters to be passed to a command handler; and
CommandTarget is the target on which command is to be invoked.

The Push Button implements the ICommandSource interface. The Call Window function is a command and source of the Call Window function is a command source. CommandParameter contains parameters such as the Call Window function source, function and window type and window name. The CommandTarget is the Function Link Component. The Command property of the Push Button is defined by the Function Link Component.

The Function Link Component will provide CommandBinding, which is mapping the command logic to the Command, so that it can link the function to its function source in run-time. The Function Link Tab is displayed for any Graphic Object that implements ICommandSource interface.

In order to ensure that the function, in this case the Call Window, is available for linking, solution providers have to register its Function Source implementations of the design-time and run-time interfaces with the Function Link Component. The registration can be done during the installation of the Function Source for design-time or run-time.

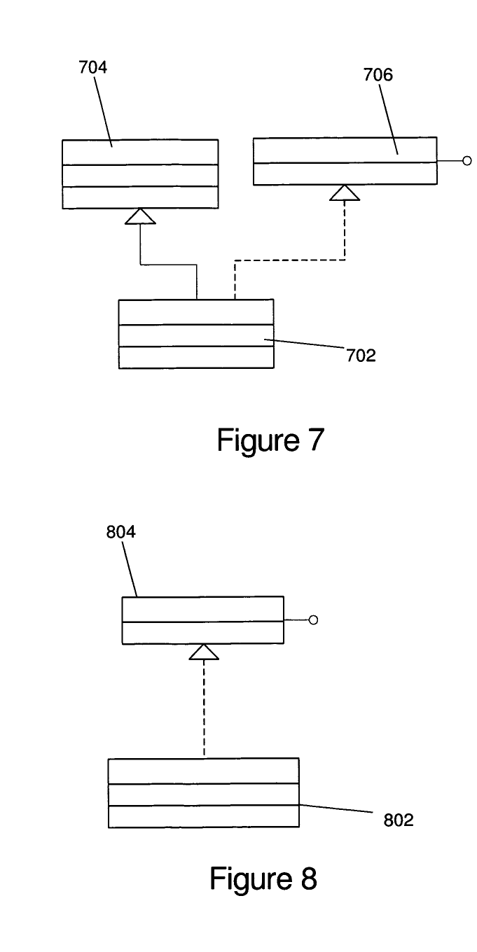

The Function Source during the design time, is illustrated in FIG. 7 and is represented by reference numeral 702. It implements the design time interface 706 as defined by the Function Link Component and the implemented design time interface contains two members. The first member is a method which is called when the Engineer has completed the function linking operation to get the function and parameter strings. The Function Link Component stores the function information with the Graphic Object and registers any assigned identifiers. The second member is an event. The implemented design time interface triggers the event which in turn requests the Function Link Component to validate the parameter string and/or identifier names. Any violation detected during the validation process is directly displayed to the Engineer by the Function Link Component. Further, a Generic Name support is another feature of the interface which the Engineer can use to specify parameters having values which are determined at the run-time by the Operator or by the system. The Function Source also needs to provide the User Interface Control, represented by reference numeral 704 for selecting the desired function.

The Function Link Component hosts the design-time interface for the Engineer to select a desired function to be linked with the Graphic Object. When the Engineer launches the property dialog of the Graphic Object, the Function Link Component will display the Function Link Tab. This tab will contain a list of function sources. For a selected function source, its user interface for selecting the desired function is displayed to the Engineer. This user interface is further used for specifying the Function Link information. The Function Link Component will query the Function Source for function and parameter strings. The Function Link Component stores the Function Link information, function and parameter strings are stored with the Graphic Object. While storing the information, the Function Link Component adds an identifier for the Function Source. This helps to identify which is the Function Source that the function and parameter strings need to be passed on.

The function and parameter string contain the name of the function to be invoked and the parameter string. The function and parameter strings are parsed for generic names and any violation in syntax is reported.

The Engineer can further specify a check condition. The function will be executed when invoked only if the specified condition is satisfied. If the condition is blank, the function will always be executed when invoked.

The Function Source during the run-time is illustrated in FIG. 8 and represented by the reference numeral 802. It implements the run-time interface 804 and the implemented run-time interface contains one member. The member inputs the parameter string as defined during the design-time, identifies the function to be executed and passes the parameters from the parameter string to the function.

The actual execution of the function is done by the function source. If the function is linked to a Graphic Object, the function is executed by a user action for example the click of a button. Otherwise, the function can be configured to be executed after certain events for example after initialisation or prior to closing the Graphic Interface. When the function is triggered from a Graphic Object, it will invoke the Function Link Component with the function parameter. The function parameter contains the identifier, generated during the design-time, for the Function Source, the function to be executed and its parameter as defined during the design-time. The Function Link Component executes the function and its parameters, identifies the Function source to execute the function.

In this invention, functions from Function Sources having different interfaces can be added to Graphic Objects by providing a repository of interfaces which can be used for the configuration and application Graphic page. Further prior to adding a function to the Graphic Objects, a Function Link Component is provided to perform all the necessary validation and checks. The checks include ensuring that the implemented interfaces of the Function Source for the function match those in the repository and to execute the functions; the validation includes validating the parameters and identifiers.

1. A system for configuring and applying a graphical user interface to monitor and control the making or treatment of a product, comprising:
(a) a first repository having a plurality of function sources implementing pre-defined first and second interfaces;
(b) a second repository for storing the configured graphical user interface and the information of the selected function source;
(c) a function link component for
(i) selecting a function source in said first repository during the configuration of said graphical user interface; and
(ii) activating said function source during the application of the graphical user interface.

2. A system as claimed in claim 1 wherein
said first repository further includes function components of said plurality of function sources, and
said function link component further includes
means for selecting a function component during the configuration of said graphical user interface; and
means for invoking said function during the application of said graphical user interface.

3. A method for configuring and applying a graphical user interface having function components of different function sources to monitor and control the making or treatment of a product, comprising the steps:
(a) defining a plurality of function sources for the configuration and application of said graphical user interface;
(b) determining whether a function source matches one of said defined function sources;
(c) linking said function source to said graphical user interface when said function source matches one of said defined function sources during the configuration of said graphical user interface; and
(d) activating said function source during the application of said graphical user interface.

4. A method for configuring and applying a graphical user interface having function components of different function sources to monitor and control the making or treatment of a product, comprising the steps:
(a) defining a plurality of first interfaces for the configuration of said graphical user interface;
(b) defining a plurality of second interfaces for the application of said graphical user interface;
(c) determining if the first and second interfaces implemented by a function source match the defined first and second interfaces;
(d) linking said function source to said graphical user interface when said implemented first and second interfaces match one of said defined first and second interfaces during the configuration of said graphical user interface; and
(e) activating said function source during the application of said graphical user interface.

5. A method as claimed in claim 4 further comprising the step of defining a plurality of function sources having implemented first and second interfaces which match one of the defined first and second interfaces.

6. A method for configuring and applying a graphical user interface having function components of different function sources to monitor and control the making or treatment of a product, comprising the steps:
(a) defining a plurality of function sources for the configuration and application of said graphical user interface;
(b) selecting a function source from the defined function sources during the configuration;
(c) linking the selected function source to said graphical user interface during the configuration of said graphical user interface; and
(d) activating the selected function source during the application of said graphical user interface.

7. A method for configuring and applying a graphical user interface having function components of different function sources to monitor and control the making or treatment of a product comprising the steps:
(a) defining a plurality of first interfaces which can be used for the configuration of said graphical user interface;
(b) defining a plurality of second interfaces which can be used during the application of said graphical user interface;
(c) selecting a function source having implemented interfaces which match the defined first and second interfaces;
(d) linking the selected function source to said graphical user interface during the configuration of said graphical user interface; and
(e) activating the selected function source during the application of said graphical user interface.

8. A method as claimed in claim 7 further comprising the step of defining a plurality of function sources having implemented first and second interfaces which match one of the defined first and second interfaces.

9. A method as claimed in claim 3 further including the steps of
defining a plurality of function components;
selecting a function component during the configuration of said graphical user interface; and
invoking said function component during the application of said graphical user interface.

10. A method as claimed in claim 3 wherein the step of linking the selected function source to said graphical user interface further comprises the step of providing a user interface of said selected function source for a user to configure the function source.

11. A method as claimed in claim 3 wherein the step of linking the selected function source to said graphical user interface further comprises the step of registering a generic name for said selected function source.

12. A method as claimed in claim 3 wherein the step of linking the selected function source to said graphical user interface further comprises the step of defining conditions for enabling or disabling the activation of the function source during the application of the graphical user interface.

13. A method as claimed in claim 3 wherein the step of linking the selected function source to said graphical user interface further comprises the step of storing the configured graphical user interface and the selected function sources.

14. A method as claimed in claim 3 further comprising the step of providing a function link component for
storing the defined function sources and/or the first and second interfaces;
generating a user interface for configuring a function and parameters of a function source during the configuration of the graphical user interface;
selecting a function source during the configuration; and
activating the function source during the application.

15. A method as claimed in claim 3 further comprising the steps of providing a function link component for
storing the defined function sources and/or the first and second interfaces;
supporting web services as function sources;
generating a user interface for configuring a function and parameters of such a function source during the configuration of the graphical user interface;
selecting a function source during the configuration; and
activating the function source during the application.
